(19) United States
(12) Patent Application Publication
(10) Pub. No.: US 2018/0056441 A1
(43) Pub. Date: Mar. 1, 2018

(54) LASER CONTROLLER

(71) Applicant: FANUC CORPORATION, Minamitsuru-gun (JP)

(72) Inventors: Takayoshi Matsumoto, Minamitsuru-gun (JP); Takeshi Mochida, Minamitsuru-gun (JP)

(73) Assignee: FANUC CORPORATION, Minamitsuru-gun (JP)

(21) Appl. No.: 15/684,166

(22) Filed: Aug. 23, 2017

(30) Foreign Application Priority Data
Aug. 26, 2016 (JP) 2016-165399

(51) Int. Cl. B23K 26/062; B23K 26/03; B23K 26/08

(52) U.S. Cl. CPC B23K 26/062; B23K 26/0869; B23K 26/0344

(57) ABSTRACT

A laser controller is configured to output a laser beam in response to the input of command power. The laser controller receives the input of the command power and the input of an acceleration of the relative movement of a laser machining head and a workpiece, calculates output power based on the command power and a coefficient corresponding to the acceleration, and outputs the laser beam according to the calculated output power.

### BACKGROUND OF THE INVENTION

### Field of the Invention

The present invention relates to a laser controller, and more particularly, to a technique configured to maintain the machined surface quality by changing the output of a laser beam in accordance with an axis operation during laser machining.

### Description of the Related Art

In laser machining, the machining speed, power, frequency, duty and other factors influence the quality of a cut surface of a workpiece. If there is any corner portion in a manufacturing path, for example, a laser machining head is decelerated and accelerated at the corner portion. At the corner portion, as this is done, the machining speed is changed, so that energy applied to the workpiece per machining length varies. Since the relative speed of the workpiece and the laser machining head is then reduced, adverse effects are caused, such as reduced machining accuracy, rough machined cross-section, and reduced material quality of the workpiece.

Japanese Patent Applications Laid-Open Nos. 1-197084 and 61-226197 disclose, as a method for suppressing adverse effects, how a numerical controller for controlling the operation of the laser machining head automatically changes the power, frequency, and duty so as to be proportional to the laser machining head speed.

FIG. 1 is a block diagram showing a typical prior art configuration.

A machining program analysis unit 12 of a numerical controller (CNC) 10 analyzes a machining program 11 and outputs command power, command frequency, and command duty. An interpolation processing unit 13 performs interpolation processing and calculates speed information of a laser machining head. A movement command output unit 14 outputs a movement command based on the result of the interpolation processing. A servo control unit 15 controls a servomotor 17 based on the movement command. The servomotor 17 moves the laser machining head (not shown). On the other hand, a laser beam command calculation unit 16 calculates and outputs power, frequency, and duty suited for the target speed based on the speed information of the laser machining head and the command power, command frequency, and command duty. Then, a laser oscillator (not shown) outputs a laser beam in accordance with the power, frequency, and duty suited for the speed.

However, the above prior art relates to a laser output control technique for the numerical controller. In general, high technical capabilities are needed to program the numerical controller in order to perform the control disclosed in the prior art examples. For example, many robot manufacturers do not have a large stock of know-how about laser machining and cannot easily program the numerical controller to create continuous or pulsatile power commands in consideration of the acceleration and deceleration of the laser machining head.

Generally, moreover, the laser oscillator itself is provided with only an interface for power- and beam-on/off and does not have a function to control power in accordance with the acceleration and deceleration.

Thus, in a system with a robot for laser welding and cutting, the same power, frequency, or duty for uniform speed conditions is also used when the laser machining head is accelerated or decelerated, so that machining defects such as burrs are undesirably caused.

FIG. 2 is a block diagram showing a configuration example of a conventional laser machining robot.

A laser beam command unit 21 of a robot 20 outputs command power, command frequency, command duty, and a beam-on or -off command. A laser beam command calculation unit 22 outputs power and a beam-on or -off command to a laser oscillator 23 based on the commands received from the laser beam command unit 21. The laser oscillator 23 outputs a laser beam based on the commands received from the laser beam command calculation unit 22. The commands input to the laser oscillator 23 include no information related to the speed of the laser machining head (not shown) or the like at all. Thus, the laser oscillator 23 cannot perform laser output control based on the speed or the like.

### SUMMARY OF THE INVENTION

The present invention has been made to solve the above problems and its object is to provide a laser controller capable of maintaining the machined surface quality by changing the output of a laser beam in accordance with an axis operation during laser machining.

A laser controller according to a first embodiment of the present invention is configured to output a laser beam in response to the input of command power and comprises an input unit configured to accept the input of the command power and the input of an acceleration of the relative movement of a laser machining head and a workpiece, a laser control unit configured to calculate output power based on the command power and a coefficient corresponding to the acceleration, and a D/A conversion unit configured to output the laser beam according to the output power.

The laser control unit may be configured to perform such control as to gradually increase or decrease the output power while the relative movement of the laser machining head and the workpiece is being accelerated or decelerated.

A laser controller according to a second embodiment of the present invention is configured to output a laser beam in response to the input of command power and comprises an input unit configured to accept the input of the command power and the input of a speed of the relative movement of a laser machining head and a workpiece, a laser control unit configured to calculate output power based on the command power and a coefficient corresponding to a change of the speed, and a D/A conversion unit configured to output the laser beam according to the output power.

The laser control unit may be configured to perform such control as to gradually increase or decrease the output power while the relative movement of the laser machining head and the workpiece is being accelerated or decelerated.

According to the present invention, there can be provided a laser controller capable of maintaining the machined surface quality by changing the output of a laser beam in accordance with an axis operation during laser machining.

### BRIEF DESCRIPTION OF THE DRAWINGS

FIG. 1 is a diagram showing a configuration example of a numerical controller for controlling conventional laser machining;

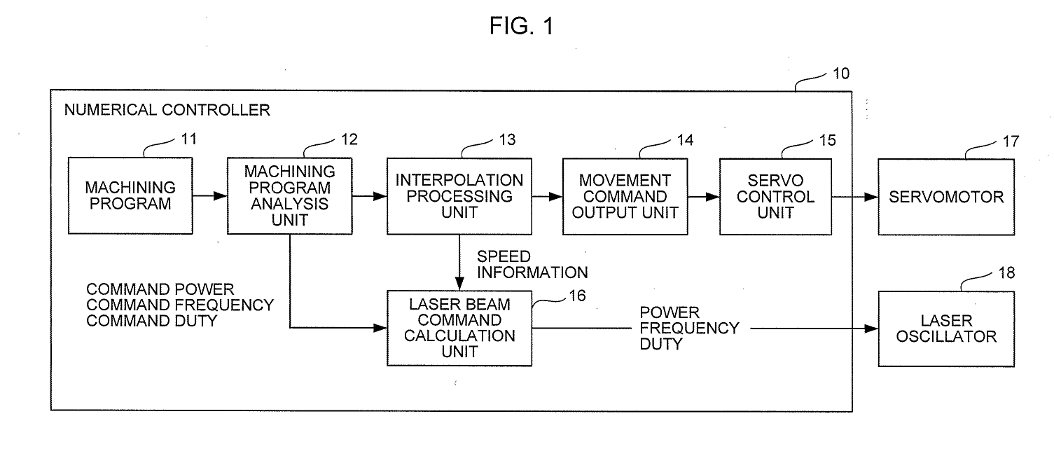

FIG. 2 is a diagram showing a configuration example of a robot used to perform the conventional laser machining;

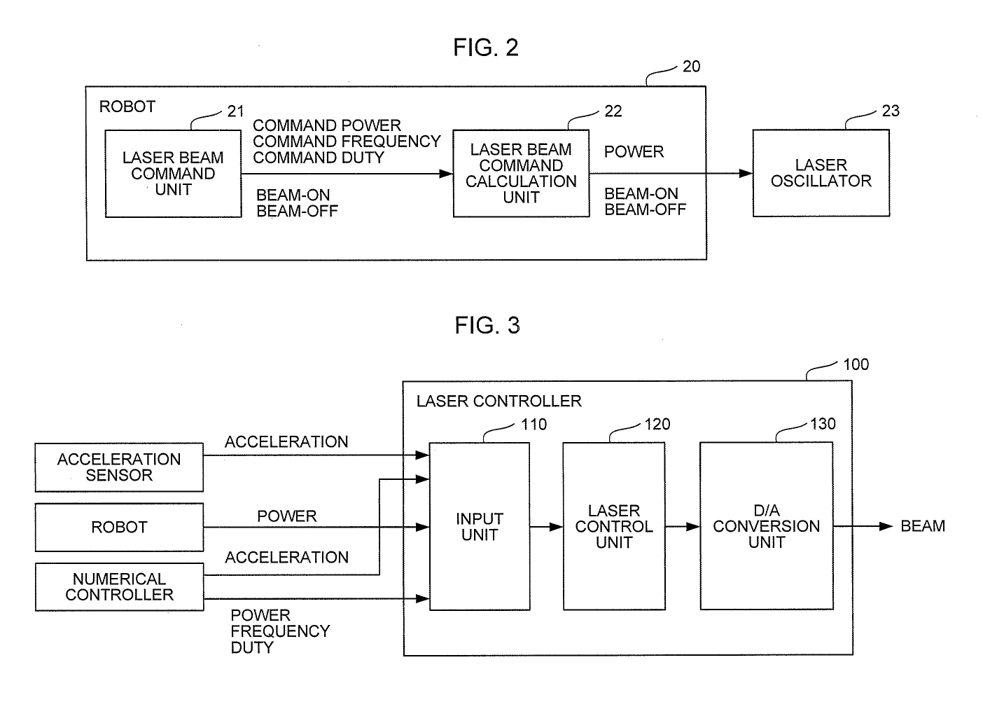

FIG. 3 is a diagram showing the configuration of a laser controller according to Embodiment 1 of the present invention;

FIG. 4 is a diagram showing the operation of the laser controller according to Embodiment 1 of the present invention;

FIGS. 5A and 5B are diagrams showing the operation of the laser controller according to Embodiment 1 of the present invention; and

FIG. 6 is a diagram showing the configuration of a laser controller according to Embodiment 2 of the present invention.

### DETAILED DESCRIPTION OF THE PREFERRED EMBODIMENTS

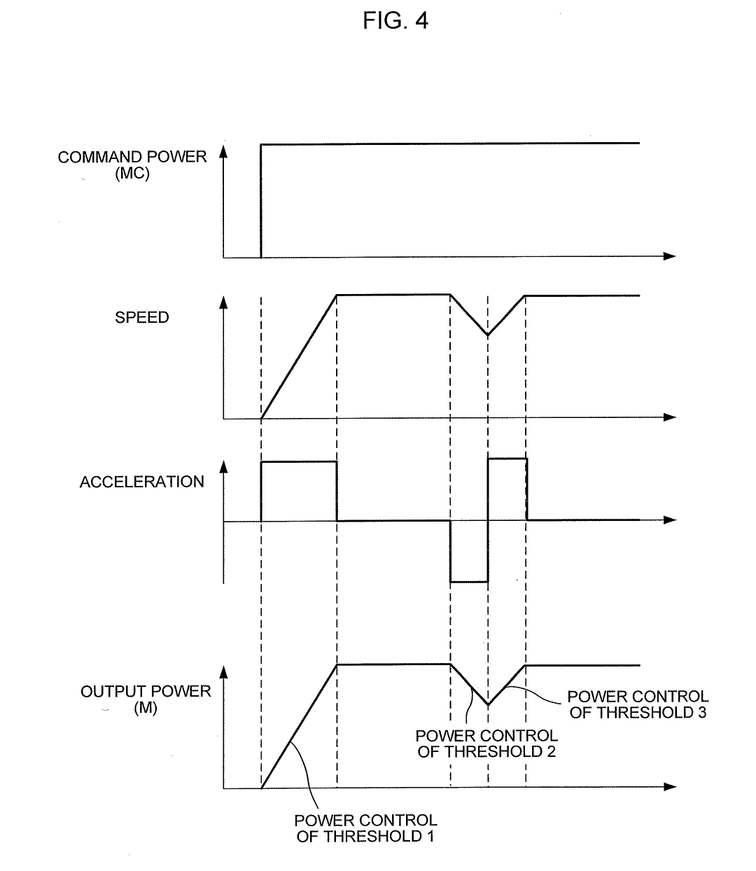

A laser controller according to Embodiment 1 of the present invention will first be described with reference to FIGS. 3 to 5B.

The configuration of a laser controller 100 according to Embodiment 1 of the present invention will be described with reference to the block diagram of FIG. 3. The laser controller 100 comprises an input unit 110, laser control unit 120, and D/A conversion unit 130.

The input unit 110 accepts the input of acceleration information in addition to commands such as a power command, frequency command, and duty command. Typically, a robot or numerical controller (CNC) outputs the power, frequency, duty and other commands. An acceleration sensor mounted on a table that carries a laser machining head or workpiece thereon outputs an acceleration. Preferably, these pieces of information should be digital information and the input unit 110 should be provided with a digital input interface such as Ethernet (registered trademark).

Alternatively, acceleration information generated by an interpolation processing unit of the CNC in place of the acceleration sensor may be input to the input unit 110. The interpolation processing unit, which executes interpolation processing based on an acceleration command, can generate and output the acceleration during the execution.

The laser control unit 120 monitors the acceleration which is input to the input unit 110. At the same time, it calculates laser output power by multiplying the input command power by a coefficient corresponding to the input acceleration.

The D/A conversion unit 130 outputs a laser beam based on the output power calculated by the laser control unit 120 and the command frequency and command duty input to the input unit 110.

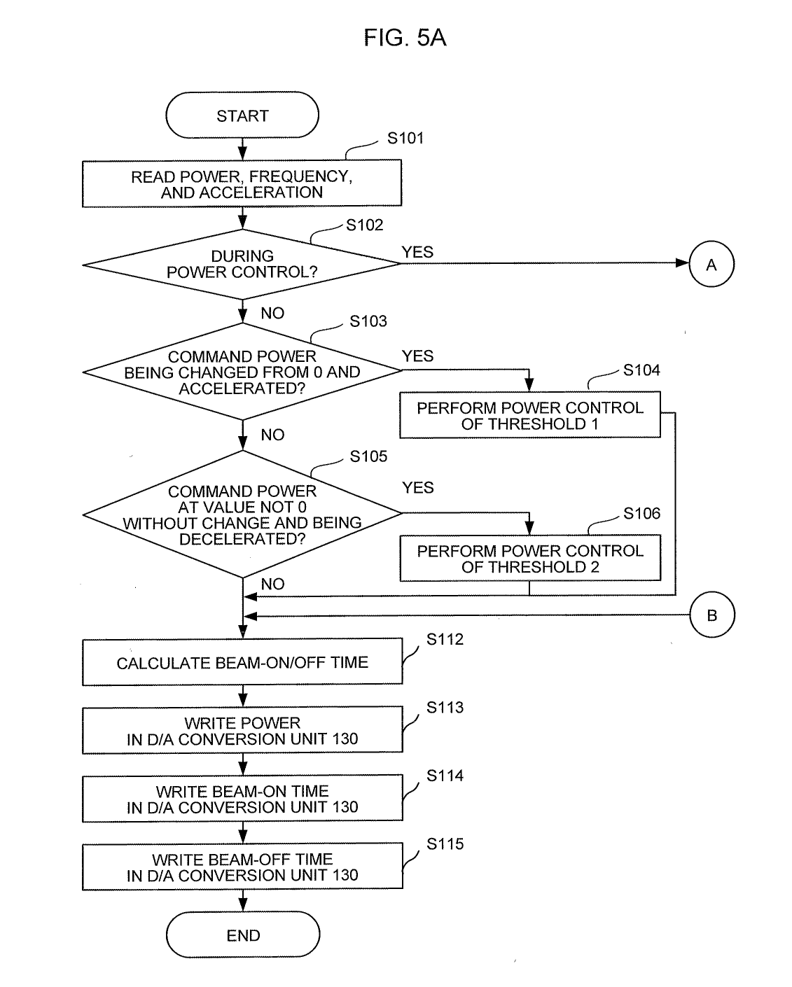

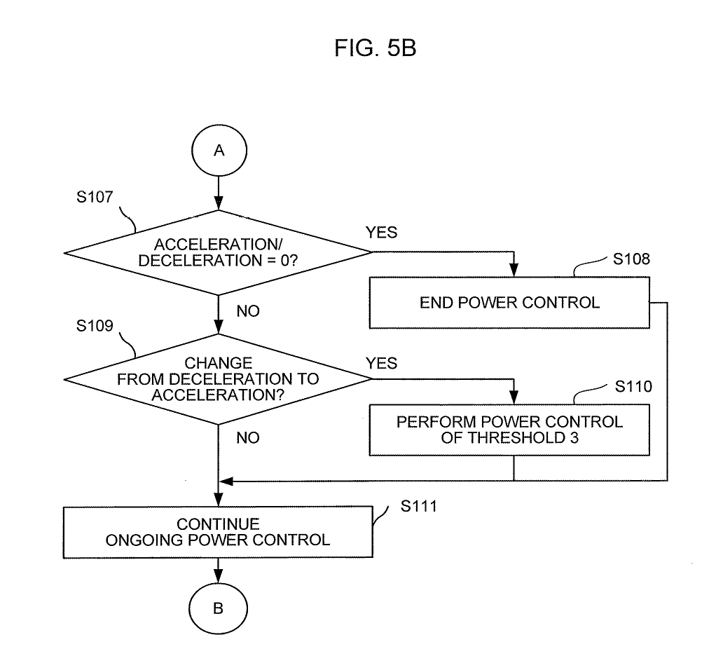

The operation of the laser controller 100 according to Embodiment 1 will now be described with reference to the flowcharts of FIGS. 5A and 5B and the chart of FIG. 4.

The laser controller 100 performs continuous power control by repeatedly carrying out the processing shown in FIGS. 5A and 5B at regular time intervals. In the description to follow, control performed by the laser control unit 120 as the relative movement of the laser machining head and the workpiece is accelerated immediately after the input of the command power will be referred to as “power control of Threshold 1”; control performed by the laser control unit 120 when the relative movement of the laser machining head and the workpiece is decelerated after becoming uniform as “power control of Threshold 2”, and control performed by the laser control unit 120 after the relative movement is changed from deceleration to acceleration as “power control of Threshold 3” (FIG. 4).
Step S101: The input unit 110 accepts the input of the command power, command frequency, and command duty from the robot or CNC.
Step S102: If the laser control unit 120 is already performing the power control, the program proceeds to Step S107. If not, the program proceeds to Step S103.
Step S103: The laser control unit 120 determines whether or not the command power that is input to the input unit 110 is changed from 0 to a positive value (that is, any command power is input) and the acceleration has a positive value (that is, the speed of the relative movement of the laser machining head and the workpiece is being increased). Whether or not the command power is changed from 0 to the positive value can be determined by comparing the command power read in Step S101 and the command power for the immediately preceding cycle. If the result of the determination is true, the program proceeds to Step S104. If not, the program proceeds to Step S105.
Step S104: The laser control unit 120 performs the “power control of Threshold 1”. The laser control unit 120 calculates the output power according to equation (1) as follows:

M=M_{c}×ΣΔk₁. (1)

Here M is the output power, M_{c} is the command power, and Δk₁ is a predefined magnification. Specifically, the laser control unit 120 performs control such that the output power is increased at the rate Δk₁ per unit time before the speed of the relative movement of the laser machining head and the workpiece becomes uniform and that the command power M_{c} of 100% is output when the speed of the relative movement of the laser machining head and the workpiece becomes uniform.
Step S105: The laser control unit 120 determines whether or not the command power input to the input unit 110 has a positive value other than 0 and is not changed and that the acceleration has a negative value (that is, the relative movement of the laser machining head and the workpiece is being decelerated). Whether the command power is not changed can be determined by comparing the command power read in Step S101 and the command power for the immediately preceding cycle. If the result of the determination is true, the program proceeds to Step S106. If not, the program proceeds to Step S112.
Step S106: The laser control unit 120 performs the “power control of Threshold 2”. The laser control unit 120 calculates the output power according to equation (2) as follows:

M=M_{c}×(1−ΣΔk₂). (2)

Here M is the output power, M_{c} is the command power, and Δk₂ is a predefined magnification. Specifically, the laser control unit 120 performs control such that the output power is reduced from the command power M_{c} of 100% at the rate Δkₑ per unit time when the relative movement of the laser machining head and the workpiece is changed from uniform motion to deceleration.
Step S107: The laser control unit 120 determines whether or not the acceleration that is input to the input unit 110 is 0 (that is, the relative movement of the laser machining head and the workpiece is uniform). If the result of the determination is true, the program proceeds to Step S108. If not, the program proceeds to Step S109.
Step S108: The laser control unit 120 ends the power control.
Step S109: The laser control unit 120 determines whether or not the acceleration is changed from the negative value to a positive value (that is, the relative movement of the laser machining head and the workpiece is changed from deceleration to acceleration). Whether or not the command power is changed from the negative value to the positive value can be determined by comparing the command power read in Step S101 and the command power for the immediately preceding cycle. If the result of the determination is true, the program proceeds to Step S110. If not, the program proceeds to Step S111.
Step S110: The laser control unit 120 performs the “power control of Threshold 3”. The laser control unit 120 calculates the output power according to equation (3) as follows:

M=M_{c}×(1−ΣΔk₂+ΣΔk₃). (3)

Here M is the output power, M_{c} is the command power, and Δkₑ and ΣΔk₃ are predefined magnifications. Specifically, the laser control unit 120 performs control such that the output power is increased from the then command power M=M_{c}×(1−ΣΔk₂) at the rate Δk₃ per unit time when the relative movement of the laser machining head and the workpiece is changed from deceleration to acceleration.
Step S111: The laser control unit 120 continues the ongoing power control.
Steps S112 to S115: The laser control unit 120 calculates the on/off time of the laser beam based on the command frequency and the command duty input to the input unit 110 in Step S101. The laser control unit 120 outputs power, beam-on time, and beam-off time to the D/A conversion unit 130. The D/A conversion unit 130 outputs the laser beam according to the input power, beam-on time, and beam-off time.

According to the present embodiment, the laser control unit 120 of the laser controller 100 calculates appropriate output power in accordance with the acceleration of the relative movement of the laser machining head and the workpiece, thereby controlling the output of the laser beam. More specifically, the laser control unit performs control such that the output power is gradually increased while the relative movement of the laser machining head and the workpiece is being accelerated. On the other hand, the laser control unit performs control such that the output power is gradually decreased while the relative movement of the laser machining head and the workpiece is being decelerated. Therefore, it is unnecessary to create a power command in consideration of the acceleration and deceleration of the relative movement of the laser machining head and the workpiece on the CNC side. By combining the laser controller 100 with a conventional laser machining robot or the like, the output power can be controlled in consideration of the acceleration and deceleration of the relative movement of the laser machining head and the workpiece.

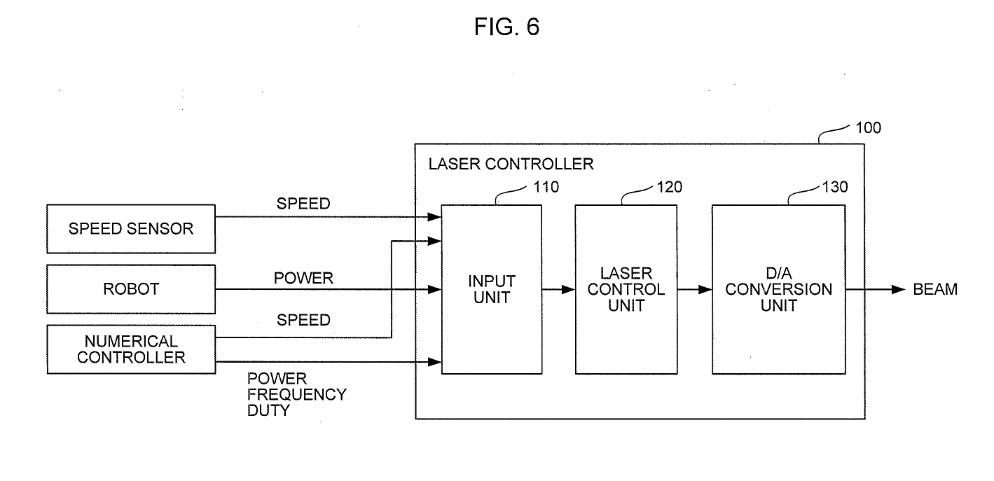

A laser controller according to Embodiment 2 of the present invention will now be described with reference to FIG. 6 and FIGS. 5A and 5B.

A laser controller 100 according to Embodiment 2 is characterized in that speed information is used in place of the acceleration information used in Embodiment 1. Differences of the configuration and operation of Embodiment 2 from those of Embodiment 1 will be mainly described in the following, and a description of points common to these embodiments will be omitted below.

The configuration of the laser controller 100 according to Embodiment 2 of the present invention will be described with reference to the block diagram of FIG. 6.

An input unit 110 accepts the input of speed information in addition to commands such as a power command, frequency command, and duty command. Typically, a speed sensor mounted on a table that carries a laser machining head or workpiece thereon outputs a speed.

Alternatively, speed information generated by the interpolation processing unit of the CNC in place of the speed sensor may be input to the input unit 110. The interpolation processing unit, which executes interpolation processing based on a speed command, can generate and output the speed during the execution.

The laser control unit 120 monitors the speed input to the input unit 110. At the same time, it calculates laser output power by multiplying the input command power by a coefficient corresponding to the change of the speed.

The operation of the laser controller 100 according to Embodiment 2 will now be described with reference to the flowcharts of FIGS. 5A and 5B.

According to Embodiment 1 described above, the laser control unit 120 uses the acceleration information, in Steps S103, S105, S107 and S109, in order to determine whether the relative movement of the laser machining head and the workpiece is being accelerated, in uniform motion, or being decelerated. According to Embodiment 2, in contrast, the laser control unit 120 uses the speed information to determine whether the relative movement of the laser machining head and the workpiece is being accelerated, in uniform motion, or being decelerated.

For example, the laser control unit 120 can determine whether the relative movement of the laser machining head and the workpiece is being accelerated, in uniform motion, or being decelerated by comparing the speed read in Step S101 and the speed read in the immediately preceding cycle.

Alternatively, the laser control unit 120 may be configured to read a target speed in addition to the current relative movement speed of the laser machining head and the workpiece in Step S101. In this case, if the current speed is equal to the target speed (or within a fixed error range), the relative movement of the laser machining head and the workpiece can be determined to be in uniform motion. If the current speed is different from the target speed, in contrast, the relative movement of the laser machining head and the workpiece can be determined to be being accelerated or decelerated.

Also in the present embodiment, the laser control unit 120 of the laser controller 100 can calculate appropriate output power in accordance with the acceleration of the laser machining head, thereby controlling the output of the laser beam. In Embodiment 2, compared with Embodiment 1, extra processing is needed to determine the acceleration, deceleration, and uniform motion. Moreover, if the target speed is used, the input unit 110 is expected to secure variables for accepting the input of the two data, the current and target speeds.

The present invention is not limited to the above-described embodiment and may be suitably changed without departing from the spirit of the invention. Any of the constituent elements of the embodiments may be modified or omitted without departing from the scope of the present invention.

1. A laser controller configured to output a laser beam in response to the input of command power, the laser controller comprising:
an input unit configured to accept the input of the command power and the input of an acceleration of the relative movement of a laser machining head and a workpiece;
a laser control unit configured to calculate output power based on the command power and a coefficient corresponding to the acceleration; and
a D/A conversion unit configured to output the laser beam according to the output power.

2. A laser controller configured to output a laser beam in response to the input of command power, the laser controller comprising:
an input unit configured to accept the input of the command power and the input of a speed of the relative movement of a laser machining head and a workpiece;
a laser control unit configured to calculate output power based on the command power and a coefficient corresponding to a change of the speed; and
a D/A conversion unit configured to output the laser beam according to the output power.

3. The laser controller according to claim 1, wherein the laser control unit performs such control as to gradually increase the output power while the relative movement of the laser machining head and the workpiece is being accelerated.

4. The laser controller according to claim 1, wherein the laser control unit performs such control as to gradually decrease the output power while the relative movement of the laser machining head and the workpiece is being decelerated.
